(19) United States
(12) Patent Application Publication
(10) Pub. No.: US 2009/0145420 A1
(43) Pub. Date: Jun. 11, 2009

(54) Disposable Microwaveable Food Container Warmer

(76) Inventor: Brent WHITIS, Killeen, TX (US)

Correspondence Address: KAMMER BROWNING PLLC, 7700 BROADWAY, SUITE 202, SAN ANTONIO, TX, 78209, US

(21) Appl. No.: 12/253,925

(22) Filed: Oct. 17, 2008

Related U.S. Application Data
(60) Provisional application No. 60/980,511, filed on Oct. 17, 2007.

(51) Int. Cl. A47G 23/04; F24C 15/34; H05B 6/80

(52) U.S. Cl. 126/246; 126/400

(57) ABSTRACT

A disposable enclosure or sealed envelope packet configured to be used for the purpose of warming objects and utensils intended for use in conjunction with prepared food products. The warming packet incorporates organic material and is shaped and sized to be positioned next to a food container and to thereby keep the container warm as well as the food within or on the container. The organic material contained within the packet is susceptible to warming by microwave ovens and retains such heat energy for a period of time to assist in the maintenance of warmth in the food products. In a preferred embodiment, flat circular shaped packets are designed to incorporate organic materials such as a starch (rice grains or the like) as well as a heat retention material (such as crystalline salt). The packets are heated in a microwave oven, individually or collectively in a stack, and then placed in between empty plates for the purposes of maintaining the plates in a warm condition prior to being used to serve food. In addition, the present invention anticipates a removable, re-usable cover for the individual packets that would facilitate the handling of the packets and provide a more attractive surface upon which the service ware and the food might be placed.

### CROSS REFERENCE TO RELATED APPLICATIONS

This application claims the benefit under Title 35 United States Code § 119(e) of U.S. Provisional Application No. 60/980,511; Filed: Oct. 17, 2007, the full disclosure of which is incorporated herein by reference.

### BACKGROUND OF THE INVENTION

1. Field of the Invention

The present invention relates generally to utensils and containers utilized in conjunction with food and food preparation. The present invention relates more specifically to devices for warming and maintaining warmth in prepared foods placed in or on standard food containers and service wares. The present invention includes materials that are microwaveable to absorb electromagnetic energy, convert it to heat energy (temperature increase) and retain the heat energy for later transference to objects placed in contact with the materials.

2. Description of the Related Art

The preparation of food products for consumption frequently calls for cooking such food products, placing the cooked food products on or in a container or other service ware, and then serving the prepared food on or in the container to the individuals who intend to consume the prepared food. In many food preparation and food service environments it is desirable to have the food products served hot, or at least warm, at the point in time when they are to be consumed. In many cooking and food service environments it is difficult to time the preparation and service of the meal and as a result the food does not always remain warm or hot once it is served to the consumer. A meal or plate intended to be served warm or hot is generally much less appetizing if it arrives to the consumer cold or only lukewarm.

Efforts have been made in the past to provide mechanisms for warming service plates and the like, either before or after the meal or food products have been placed on the service ware. In cases where the plates or service ware might be warm before placing the food thereon, the service ware frequently cools down well before the food is placed and served. In cases where the food is placed and then the service ware and food are together warmed, the food frequently dries out or otherwise diminishes in quality through the subsequent warming process.

A number of efforts have been made in the past to produce devices for warming food or food containers, either directly or through the use of a variety of different heating pads. There are, for example, a number of containers that have been designed to include internal materials that are chemically characterized to absorb and retain as much heat as possible and to release it gradually into the environment surrounding the material. Some such objects developed are intended to be warmed in standard oven systems, that is by way of either conductive heat transfer or radiant heat transfer, while some have been developed to absorb microwave energy and thereby internally generate heat as a result of the absorption of microwaves. U.S. Pat. No. 5,871,527 issued to Gubernick entitled Microwaveable Mixture and Heating Pad identifies a heating pad that includes a mixture of material in dry form comprising a quantity of salt (intended to function as a heat storage medium) and a quantity of starch material (intended to absorb microwave energy). The device provided by Gubernick, however, is directed to a heating pad intended for human use (i.e., in the healthcare industry) and as such its structure and composition do not translate over easily into the food service industry.

U.S. Pat. No. 5,993,480 issued to Burrows entitled Microwaveable Heating Pad with Heat Activated Fragrance also describes utilizing an organic material that is solid at room temperature and exhibits a mesocrystalline transition temperature when subjected to microwave radiation. Various configurations for this human use heating pad are described.

U.S. Pat. No. 5,630,961 issued to Salee entitled Microwave-Activated Mixed-Powder Thermal Storage Material and Method identifies using a first powder preferably comprising calcium silicate impregnated with a microwave sensitive material, and a second powder comprising calcium silicate impregnated with a phase change material. This patent describes the use of a heating pad for both personal body warming use and as a “warmth extender” for foods.

A number of additional U.S. patents describe the use of disposable heat storage units in conjunction with food products, many with a variety of different types of heat absorptive materials. U.S. Pat. No. 4,777,930 issued to Hartz entitled Disposable Heat Storage Unit describes a small square packet intended for placement within a fast food container or the like in order to maintain heat within the container during service of the food. U.S. Pat. No. 4,246,884 issued to Vandas entitled Plate Warmer describes a device intended to maintain heat within a food container for the purposes of serving the food at appropriate temperatures. Finally, U.S. Pat. No. 6,147,337 issued to Besser entitled Microwaveable Heat Retentive Receptacle describes a microwaveable element that may be positioned within an insulating container to maintain the warmth of food or a separate food container positioned over the element. Pouches containing a microwave absorbable material are provided that can be associated with a variety of different containers to improve the heat storage characteristics of the containers.

In general, therefore, the related art shows that there is some use of organic materials as the basis for absorbing microwave energy and retaining heat for the purpose of transferring it to a separate container of food or the like. A number of disposable heat retention packets are also described in the prior art, although their structures and intended uses are less applicable to the food industry, at least that industry associated with the service of food products and meals on non-disposable flatware.

It would be desirable to have a disposable warmer packet intended for use in conjunction with food containers and service ware that would readily absorb microwave energy and thereby generate heat within the packet that may then be transferred to the food service ware or container in order to maintain the warmth of food placed thereon. It would be desirable if the structural design of the packet lent itself to variations in the configuration and shape of the packet so as to be used in conjunction with a variety of different food containers and food service wares. It would further be desirable if the material that absorbed the microwave energy was non-toxic and re-useable for at least a moderate number of microwave heatings before being disposed of.

### SUMMARY OF THE INVENTION

In fulfillment of the above objects, the present invention provides a disposable enclosure or sealed envelope packet configured to be used for the purpose of warming objects and utensils intended for use in conjunction with prepared food products. The warming packet of the present invention incorporates organic material and is shaped and sized to be positioned next to a food container or an item of food service ware and to thereby keep the container warm as well as the food within or on the container. The organic material contained within the packet is susceptible to warming by microwave ovens or the like and to retain such heat energy for a sufficient period of time after being initially heated to assist in the maintenance of warmth in the service of the prepared food products. In a preferred embodiment, flat circular shaped packets are provided that are designed to incorporate organic materials such as a starch (rice grains or the like) as well as a heat retention material (such as crystalline salt). The packets may be heated in a microwave oven, individually or collectively in a stack, and then placed in between empty plates for the purposes of maintaining the plates in a warm condition prior to being used to serve prepared (cooked) food. In addition, the present invention anticipates a removable, re-usable cover for the individual disposable packets that would facilitate the handling of the packets and provide a more attractive surface upon which the service ware and food containers might be placed. Use of such covered packets would allow utilization not only in food preparation conditions, but also at food service locations such as dining tables.

### BRIEF DESCRIPTION OF THE DRAWINGS

FIG. 1 is a perspective view of a first preferred embodiment of the disposable, microwaveable warming packet of the present invention.

FIG. 2 is a plan view of the first preferred embodiment of the present invention shown in FIG. 1.

FIG. 3 is a cross-sectional view taken along Section Line A-A′ (shown in FIG. 2) disclosing the interior structure of the first preferred embodiment of the present invention.

FIG. 4 is a cross-sectional view of an alternate preferred embodiment of the present invention generally describing a variation on the method of manufacturing the device.

FIG. 5 is a plan view of a first preferred embodiment of the present invention disclosing structural steps that may be implemented in the manufacturing process of the disposable packets of the present invention according to the design shown in FIG. 3.

FIG. 6 is an assembly view of a preferred embodiment of the present invention showing a disposable packet used in conjunction with a removable cover element for use in a service environment.

FIGS. 7A-7D are perspective views of a number of different configurations and applications of the basic concept of the preferred embodiment of the present invention.

### DETAILED DESCRIPTION OF THE PREFERRED EMBODIMENTS

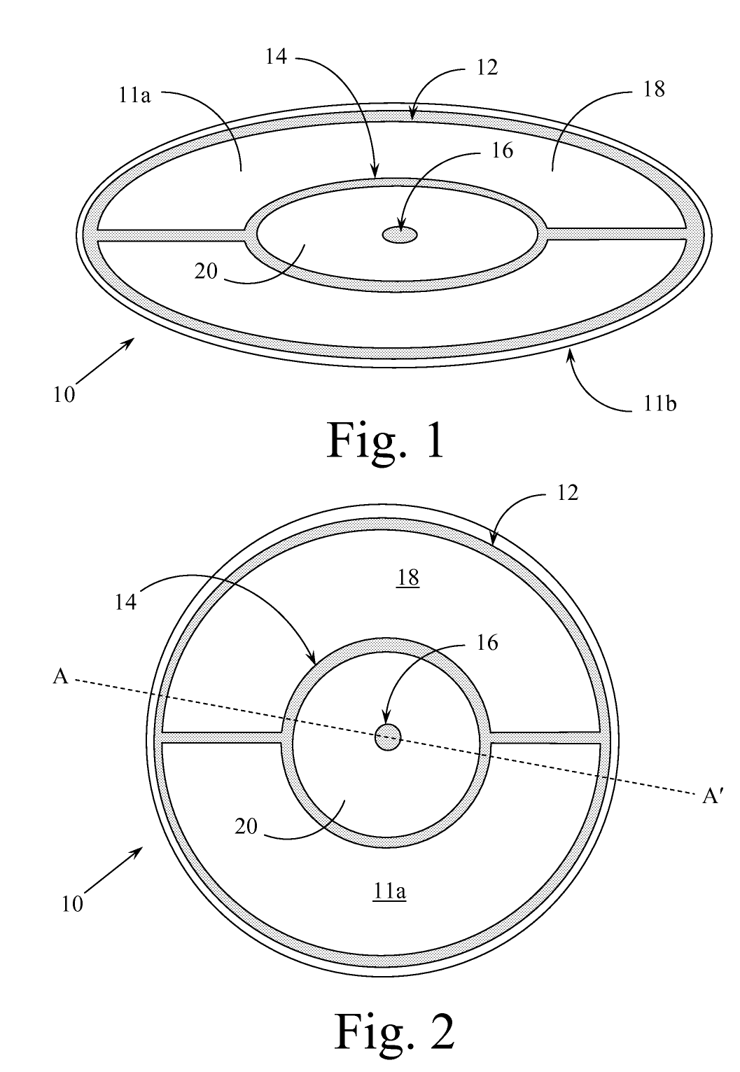

Reference is made first to FIG. 1 for a general overview of the basic structure of a disposable plate warmer configuration of a first preferred embodiment of the present invention. Warming pad 10 generally comprises two layers of a disposable sheetlike material that are sealed together in a configuration that surrounds the relevant microwave absorbing, heat retaining material. In this plate warmer configuration shown in FIG. 1, warming pad 10 comprises a first packet sheet 11a and a second packet sheet 11b (view obstructed in FIG. 1). Packet sheets 11a and 11b are sealed together, in this case primarily with two concentric ring seals, a first perimeter seal 12 near the edge of the packet and a second interior seal 14 approximately half-way between the edge and the center of the packet. In a preferred embodiment short connecting seals extend between the perimeter seal and the interior seal as shown. A final single center seal spot 16 completes what is essentially a quilted configuration to the warming pad 10. This quilting of the warming pad 10 establishes two primary regions within which the particulate material to be included in the warming pad is contained. External region 18 is defined between seal 12 and seal 14, while internal region 20 is defined between seal 14 and center seal 16. The method of incorporating the particulate material (not shown in this view) into warming pad 10 is described in more detail below.

FIG. 2 shows the same warming pad 10 described above in conjunction with FIG. 1 in a plan view to better show the overall geometry and configuration of the warming pad. It will be understood by those skilled in the art that the circular configuration shown in FIGS. 1 and 2 may be typical of a majority of the plates or service ware normally associated with the service of meals and food products, although variations of this geometry are anticipated under the present invention. Segregating the circular configuration into concentric regions 18 and 20 helps to maintain an even distribution of the material that retains the warmth initially generated through microwave energy. Absent such quilted regions, it would be possible for the material to shift to one side or the other and thereby provide uneven warming of the service ware and food products.

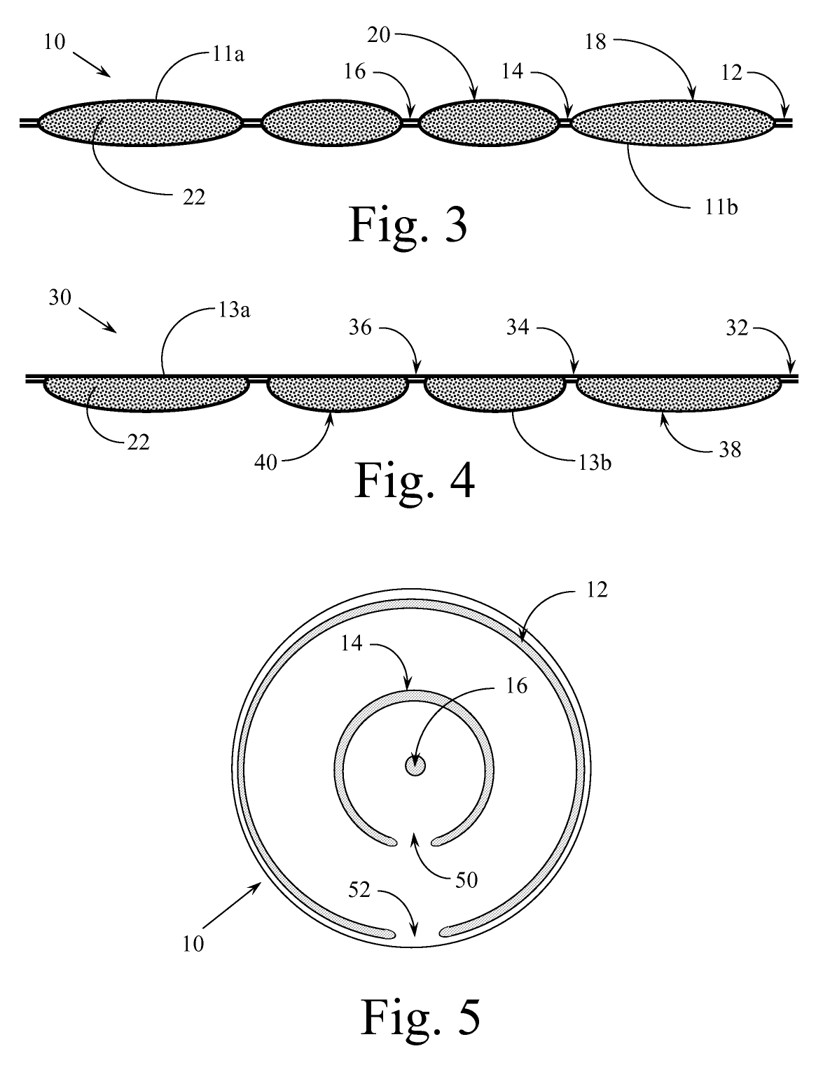

FIG. 3 is a cross-sectional view taken along cross-section Line A-A′ shown in FIG. 2. Packet sheets 11a and 11b are seen to form generally planar sheets with expanded areas arranged to contain the particulate material 22, again as described in more detail below. The various seals 12, 14, and 16 are shown in cross-section and are thereby shown to create what are essentially four regions (in cross-section) within which the particulate material 22 is maintained in order to evenly distribute the heat retention and heat release characteristics of the packet.

FIG. 4 shows an alternate construction for a preferred embodiment of the present invention whereby a first packet sheet 13b is pre-formed with indentations suitable for receiving and retaining the particulate material 22, whereafter a second flat packet sheet 13a is placed over the filled indentations and sealed as before in the first preferred embodiment described above. In this view, warming pad 30 comprises a lower pre-formed packet sheet 13b covered by a generally flat top packet sheet 13a. Seals 32, 34, and 36 are made after the packet has been filled with the particulate material 22 as shown.

The selection of the particulate material that is contained within the packet is made primarily with three objectives in mind. First, the material must readily absorb microwave energy and thereby heat up or warm up in response to the absorption of microwave energy. Second, the material must retain the heat energy for a sufficient period of time and only gradually release the energy into the environment within which the material is contained. As indicated above, certain starch materials, (readily available in the form of rice kernels), as an example, are suitable for use. Finally, it is important that the material be “organic” in nature so as to effectively be non-toxic when used with any of the food containers or food products that the device of the present invention could conceivably be used with. A number of different organically sourced materials may be suitable for this aspect of the material necessary for absorbing microwave energy. Various other, non-toxic materials such as salt crystals might be suitable for the heat retention characteristics required of the particulate material. A variety of other “organic” materials (i.e., non-toxic to humans when used in conjunction with food containers and the like) may be suitable for selection as either the heat retention component of the material or the microwave absorption component of the material.

Reference is now made to FIG. 5 for a brief description of one manner of manufacturing the disposable packets of the present invention. In FIG. 5, disposable packet 10 is shown with seals 12, 14, and 16 partially completed in the partially assembled packet. Openings are left in each of the concentric circular seals that will, as described below, allow for the insertion of the particulate material after the layers of the packet have preliminarily been assembled. In this case, aperture 50 is provided by the omission of a part of seal 14 while external aperture 52 is provided by an omission in a portion of seal 12. In this manner, and through the use of appropriate funnel-type filling devices, the particulate material described above may be inserted into the partially assembled packet to fill the spaces defined by the partial seals. After filling, the seals may then be completed by sealing across the established apertures 50 and 52.

It will be understood by those skilled in the art that a variety of different sealing mechanisms may be incorporated with the design shown. A preferable approach is to provide heat sealed sheet materials whereby additional adhesives may not be required. An example of a suitable sheet-like material that incorporates a surface composition suitable for heat sealing could include butcher paper that is backed with a waxed coating that upon heating melts and adheres to whatever surface it is in contact with. In this manner, two sheets of butcher paper material backed with waxed coating could be placed with the waxed coating sides facing each other and thereafter be cut and sealed according to the configuration shown herein. Various heating elements might be configured to appropriately instill the seal pattern to the quilted warming pad product.

The configuration shown in FIG. 4 on the other hand lends itself to a method of manufacture that does not depend upon the establishment or use of apertures in the various concentric seals. In the configuration shown in FIG. 4, the pre-established impressions or indentations in a first layer or packet wall, would allow for the particulate material to be filled into the indentations (and then smoothed off to eliminate residual material on the areas to be sealed) followed by the placement of a flat sheet of the material over top of the entire filled component. The seals could then be established in much the same manner as in the above first described embodiment, albeit that there would be no requirement to leave apertures for filling the packet after partial assembly. The packet would then be fully assembled and sealed, ready for use in a single sealing operation.

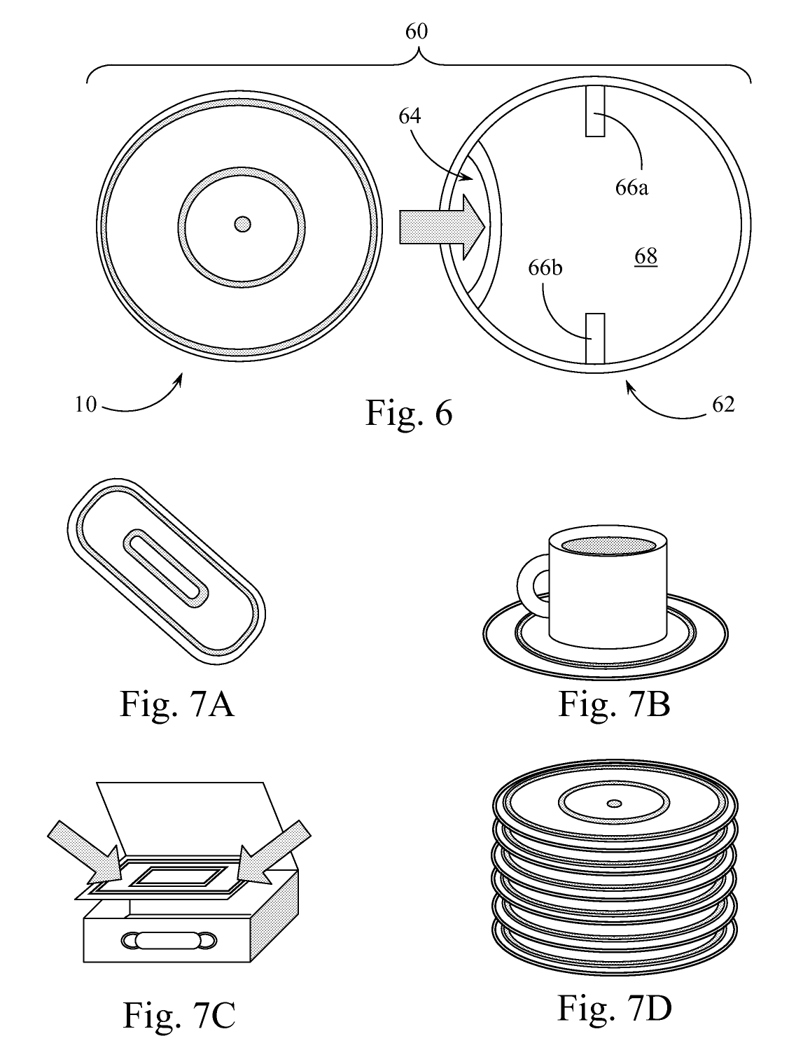

A further component of the present invention intended for use in conjunction with the disposable warming pad component comprises a re-usable cover, suitable for use in service environments with the warming device of the present invention. FIG. 6 shows this assembly 60 comprising warming pad 10 in association with fabric cover 62. In this case, cover 62 is generally configured in the same overall shape as warming pad 10 (circular in the example given) and provides an opening 64 large enough to receive warming pad 10, perhaps in an initially rolled or partially folded configuration. Cover 62 comprises two layers of fabric material that may be sewn together on a perimeter with the exception of the area where aperture 64 is positioned. A hem, or other finished edge, may be provided to the sewn envelope that is established to form cover 62. Handle tabs 66a and 66b are provided to facilitate the handling of the pad assembly 60 once the disposable component 10 has been incorporated into the cover 62 and also to handle the plate component (not shown) once it has been placed on the pad. Tabs 66a and 66b may be lifted to allow the placement of a plate (for example) on the cover with enclosed pad and to be held underneath the plate to be moved to the point of service.

FIGS. 7A-7D provide additional examples of both the construction configuration of the present invention and the various applications of use. FIG. 7A provides an elongated shape configuration such as might be suitable for use in conjunction with a bread basket or the like for service at a service table. FIG. 7B shows a smaller version of the generally circular configuration of the warming pad of the present invention as might be suitable for use to maintain warmth in a coffee cup or the like.

FIG. 7C shows an alternate configuration (rectangular in this example) of the warming pad of the present invention such as might be used in a portable food container, such as a lunchbox or a casserole dish enclosure. Finally, FIG. 7D discloses one example of the use of a number of the disposable warming pads of the present invention stacked between a number of service plates. In this manner, service plates might be heated in a large microwave over in conjunction with the alternating placed warming pads of the present invention, and thereby retain such heat for a much longer period of time in order to provide a truly warm plate at the time the food products are placed thereon.

I claim:

1. A disposable, microwaveable, warming packet for maintaining warmth in conjunction with food containers or food service ware and the like, the warming packet comprising:
(a) at least two layers of sheet like material sealed together along at least a perimeter edge of each of the layers, the sealed layered material forming an envelope enclosure; and
(b) a quantity of a mixture of particulate materials contained within the envelope enclosure, the mixture of particulate materials comprising a microwave energy absorption material and a heat energy retention material;
wherein when the warming packet is subjected to microwave energy, the temperature of the mixture of particulate materials increases and the heat energy thereby generated is retained for an extended period of time.

2. The warming packet of claim 1 wherein the microwave energy absorption material comprises a starch based product.

3. The warming packet of claim 2 wherein the starch based product comprises a quantity of grains of rice.

4. The warming packet of claim 1 wherein the heat retention material comprises a crystalline salt product.

5. The warming packet of claim 2 wherein the crystalline salt product comprises a quantity of sodium chloride salt crystals.

6. The warming packet of claim 1 wherein the mixture of particulate materials are non-toxic to humans.

7. The warming packet of claim 6 wherein the non-toxic mixture of particulate materials comprises food products and food condiments.

8. The warming packet of claim 1 wherein the at least two layers of sheet like material are configured in a circular geometry and are sealed together on a perimeter edge and on a coaxial inner ring.

9. The warming packet of claim 8 wherein the perimeter edge seal and the coaxial inner ring seal are partially open to allow introduction of the mixture of particulate material into the envelop enclosure.

10. The warming packet of claim 1 wherein the at least two layers of sheet like material are configured in a rectangular geometry and are sealed together on a perimeter edge and on a rectangular inner path.

11. A disposable, microwaveable, warming packet kit for maintaining warmth in conjunction with food containers or food service ware and the like, the warming packet kit comprising:
(a) at least two layers of sheet like material sealed together along at least a perimeter edge of each of the layers, the sealed layered material forming an envelope enclosure;
(b) a quantity of a mixture of particulate materials contained within the envelope enclosure, the mixture of particulate materials comprising a microwave energy absorption material and a heat energy retention material; and
(c) a decorative fabric cover configured to receive and at least partially cover the at least two layers of sheet like material and the contained mixture of particulate materials;
wherein when the at least two layers of sheet like material and the contained mixture of particulate materials may be subjected to microwave energy, the temperature of the mixture of particulate materials increases and the heat energy thereby generated is retained for an extended period of time, and may be covered by the fabric cover to be used in conjunction with the food containers or food service ware.

12. A disposable, microwaveable, warming packet for maintaining warmth in conjunction with food containers or food service ware and the like, the warming packet comprising:
(a) two layers of circular sheets of butcher paper sealed together along a perimeter edge and along a coaxial inner circle, the sealed butcher paper forming an envelope enclosure defining discrete concentric circular compartments; and
(b) a quantity of a mixture of particulate materials contained within the compartments of the envelope enclosure, the mixture of particulate materials comprising a microwave energy absorption material comprising grains of rice, and a heat energy retention material comprising crystals of sodium chloride salt;
wherein when the warming packet is subjected to microwave energy, the grains of rice absorb the microwave energy and convert it to heat energy thereby increasing the temperature of the grains of rice and the mixed in sodium chloride salt crystals, the heat that is thereby generated being retained for an extended period of time due to the heat retention characteristics of the salt crystals.
